(19) United States
(12) Patent Application Publication
(10) Pub. No.: US 2007/0204715 A1
(43) Pub. Date: Sep. 6, 2007

(54) LINEAR TRACKING OF STEERING ASSEMBLIES

(75) Inventor: Matthew Pankau, Brookvale (AU)

Correspondence Address: OSTROLENK FABER GERB & SOFFEN, 1180 AVENUE OF THE AMERICAS, NEW YORK, NY, 100368403, US

(73) Assignees: Matthew Pankau; Angela Pankau; Matthew Barnett; Suzanne Barnett

(21) Appl. No.: 11/746,218

(22) Filed: May 9, 2007

Related U.S. Application Data
(63) Continuation of application No. 10/925,687, filed on Aug. 25, 2004, now abandoned.

(51) Int. Cl. B62D 1/20

(52) U.S. Cl. 74/496

(57) ABSTRACT

A rack and pinion centre-steer steering assembly (10) is provided with an auxiliary drag bar (58) that attaches to the steering rack (12) and a linear bearing (66) that attaches between the drag bar (58) and the steering tube (14), so as to provide an additional point of location for the steering rack (12).

### FIELD OF INVENTION

This invention relates to steering systems for vehicles and more particularly to steering systems for automobiles, such as cars and trucks.

### BACKGROUND

A common type of steering system is a rack and pinion system in which an elongate rack having a linear gear is engaged by a geared pinion. The movable rack is mounted in a steering tube assembly that is mounted to the vehicle chassis. Rotation of the pinion causes the rack to move longitudinally within the steering tube relative to the pinion. In an automobile, tie rods connect each of the front wheels to the movable rack and movement of the rack causes the front wheels to turn. A common type of rack-and-pinion steering system is a centre-steer arrangement in which the tie rods are attached to the central section of the steering rack. In a centre-steer arrangement one end of the rack is retained by a bushing located in one end of the steering tube whilst the other end is engaged by the pinion, which is located toward the other end of the steering tube. The pinion and/or the rack are usually spring biased against each other but there is nothing to positively locate the rack relative to the steering tube at that end. This leads to free play, which in turn affects steering accuracy.

### SUMMARY OF INVENTION

In one broad form the invention provides an external linear bearing assembly that attaches between the steering tube and the rack itself, so stabilizing the rack.

Accordingly, in one broad form the invention provides a steering assembly including:

an elongate steering tube assembly;
an elongate steering rack mounted within the steering tube assembly for lengthways reciprocal motion therein;
   a linear bearing assembly located outside of the steering tube assembly and connected between the steering rack and the outside of the steering tube assembly.

The invention also provides a conversion kit for a centre steer steering assembly in which an elongate steering rack is mounted for reciprocal motion in an elongate steering tube assembly, the steering rack having a tie rod mounting location intermediate its ends, the kit including:
a linear bearing assembly for connection between the tie rod mounting location and the outside of the steering tube assembly.

In one form the linear bearing assembly includes an elongate stabilizer rod and a linear bearing. One of the stabilizer rod and the linear bearing are attached to the steering tube and the other to the rack. The stabilizer rod is mounted parallel or substantially parallel to the longitudinal direction of the rack so the bearing may slide along the stabilizer rod. The component not mounted to the rack is preferably mounted to the steering tube, but may be mounted to the vehicle chassis rather than the steering tube. However, as most steering assemblies are mounted to the vehicle chassis by rubber bushings, in most situations mounting to the steering tube is the preferred option.

In preferred forms the stabilizer rod is attached to the steering tube at or adjacent to an end remote from the pinion and the linear bearing is mounted for rectilinear movement with the movable rack.

The assembly preferably includes a drag bar assembly that attaches to the rack and the tie rods are mounted to the drag bar. The drag bar assembly may attach directly or indirectly to the movable rack. Preferably the drag bar assembly is elongate and extends parallel or substantially parallel to the rack.

When installed, the mounting points on the drag bar assembly for the tie rods may be in line with the movable rack or may be offset fore or aft relative to the movable rack.

The drag bar may include one or more sets of mounting points for the tie rods.

Preferably the linear bearing is mounted to the drag bar.

The assembly may include an extension piece for mounting onto a free end of the steering tube, with the elongate stabilizer rod mounted partially or fully on the extension.

The drag bar may be mounted directly to the movable rack or may be mounted indirectly via one or more intermediate members with the intermediate members connecting to the rack.

The intermediate member may be configured to shift the drag bar fore or aft relative to the steering rack and/or to rotate the drag bar relative to the steering rack, or neither.

Different intermediate members may be used, to vary the position of the drag bar relative to the steering tube.

Different drag bars may be used to allow the one steering assembly to be used with different models of vehicles.

The use of different intermediate members and/or different drag bars or both may allow a single design of steering rack to be utilized with different models or designs of automobiles.

### BRIEF DESCRIPTION OF DRAWINGS

FIG. 1 is an isometric view of a first embodiment of the invention;

FIG. 2 is an isometric view of the steering tube and rack assembly of the first embodiment of the invention;

FIG. 2A is an isometric view of the steering tube, rack, pinion, rack keeper and spring assembly of the first embodiment of the invention;

FIG. 3 is an enlarged isometric view of the linear bearing assembly of the first embodiment shown in FIG. 1;

FIG. 4 is a front view of a first embodiment of the invention;

FIG. 5 is an enlarged isometric view of the mounting of the drag bar assembly to the steering rack of the first embodiment shown in FIG. 1;

FIG. 6 is a longitudinal cross sectional view of the first embodiment;

FIG. 6A is an enlarged for clarity cross sectional view of a keeper and spring assembly;

FIG. 6B is an enlarged for clarity cross sectional view of tie rod mounting hole;

FIG. 7 is an enlarged for clarity, axial cross sectional view of FIG. 4;

FIG. 8 is an isometric view of a second embodiment of the invention, and

FIG. 9 is an isometric view of a third embodiment of the invention;

FIG. 10 is an enlarged for clarity axial cross sectional view of FIG. 9.

### DETAILED DESCRIPTION OF PREFERRED AND OTHER EMBODIMENTS

Referring to the drawings there is shown a steering assembly 10.

The assembly 10 has an elongate steering rack 12 mounted within an elongate steering tube 14 assembly. The steering tube assembly 14 may be a single tube or may include two or more tubes engaged end on end. The steering rack for 12 is mounted within the steering tube assembly 14 for reciprocal motion relative to the steering tube 14.

A steering shaft 16, which in use is connected to a steering wheel (not shown), drives a geared pinion wheel 18. The geared pinion wheel 18 in turn engages linear gear portion 20 of the rack 12.

The linear gear portion 20 of the rack 12 is held against the pinion 18 by a keeper 22 and a spring 24. The other end 40 of the rack 12 is rod shaped, preferably of circular cross section, which slides in a bearing 36, located at the other end 42 of the tube assembly 14. The bearing 36 is normally a simple plain type bearing.

Rotation of the pinion wheel 18 causes the rack 12 to move longitudinally relative to the tube 14. The central part of the rack 12 includes a mounting part section 32, which protrudes into and slides within slot 34 in the tube 14. The slot 34 is located between the bearing 36 and the pinion wheel 18. A sleeve 30 overlies the slot 34 and the sleeve 30 and an adaptor (or spacer) 46 are secured to the rack 12 by bolts 28, which screw into threaded bores 26. Two flexible rubber boots 44 are attached to the tube 14 and to the sleeve 30 so as to seal the slot 34 against ingress of foreign material. The adaptor 46 may be spaced from the rack 12 by a spacer (not shown) that lies between the rack 12 and the adaptor 46.

The adaptor 46 has a first section 48 and second section 50. The second section 50 extends about 45 degrees to the first section 48 and includes mounting holes 47 for mounting of a drag bar 58. Bolts 54 pass through these holes 47 and, with nuts 56, secure the drag bar 58 to the adaptor 46. A spacer 60 is sandwiched between the adaptor 46 and drag bar 58 so that the drag bar 58 clears the steering tube 14 and any associated equipment. It is to be appreciated that the angles between the first and second sections 48, 50 of the adaptor may be other than 45 degrees. The spacer 60 may be of any appropriate thickness, as required or omitted.

It will be appreciated that the adaptor and/or the spacer may be incorporated into the drag bar rather than being separate components.

The two sections 48, 50 may be coplanar, so that the drag bar is merely offset fore or aft relative to the steering rack.

The drag bar 58 extends parallel to the steering rack 12 and steering tube 14. Tie rods 62 are secured toward each end of the drag bar 58 at 61 and 63. The tie rods 62 may be located at unequal distances from the central mounting bolts 28. This is usually because, when mounted on the vehicle, the central mounting part 32 of the steering rack is not located on the centre line of the front wheels. By offsetting the mounting points 61 and 63 relative to the mounting part 32, these mounting points may be located equal distances from the centre line of the front wheels.

Mounted near the end 64 of the drag bar 58 is a linear bearing 66 that slides along an elongate stabilizer rod 68. The bearing 66 is located on a carrier 67 which is secured to the drag bar 58 by bolts 69. The ends 70, 72 of the stabilizer rod 68 are mounted on brackets 74 and 76, which in turn are mounted onto the steering tube assembly 14. Pinch bolts 77 clamp the brackets to the steering tube assembly and, when assembled, prevent rotation of the brackets about the longitudinal axis of the steering tube. Mounting the brackets on a circular part of the steering tube assembly 14 enables the brackets 74, 76 and stabilizer rod 68 to be easily aligned with the longitudinal axis of the steering tube 14. Although not shown, flexible rubber sleeves may be provided between the linear bearing 66 and the brackets 74, 76 to protect the bearing 66 and stabilizer rod 68 from damage.

The linear bearing 66 acts as a point of substantially zero free play, except parallel to the direction of movement of the steering rack 12. Together with the plain bearing 36 and the spring/keeper arrangement 22, 24 this reduces the amount of free play in the steering system compared to a system without the linear bearing assembly.

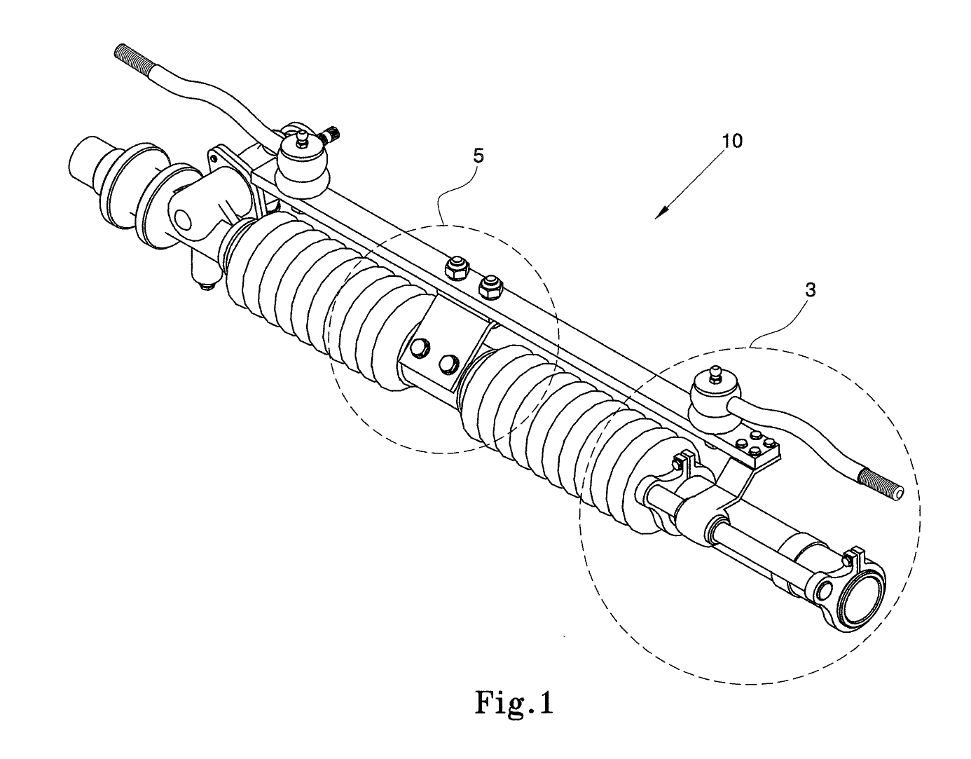

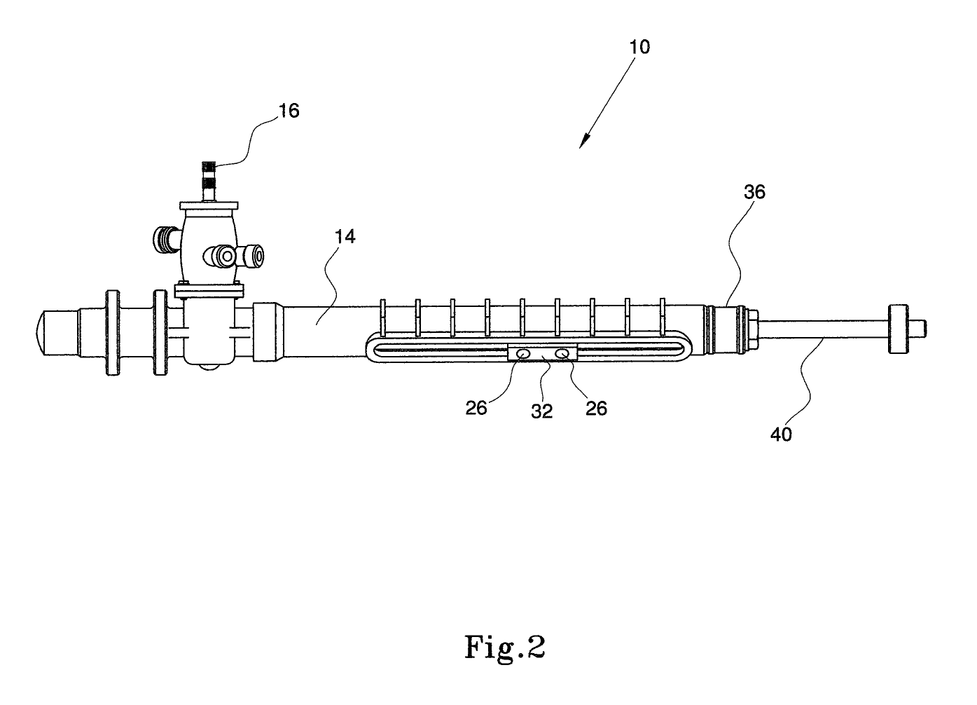

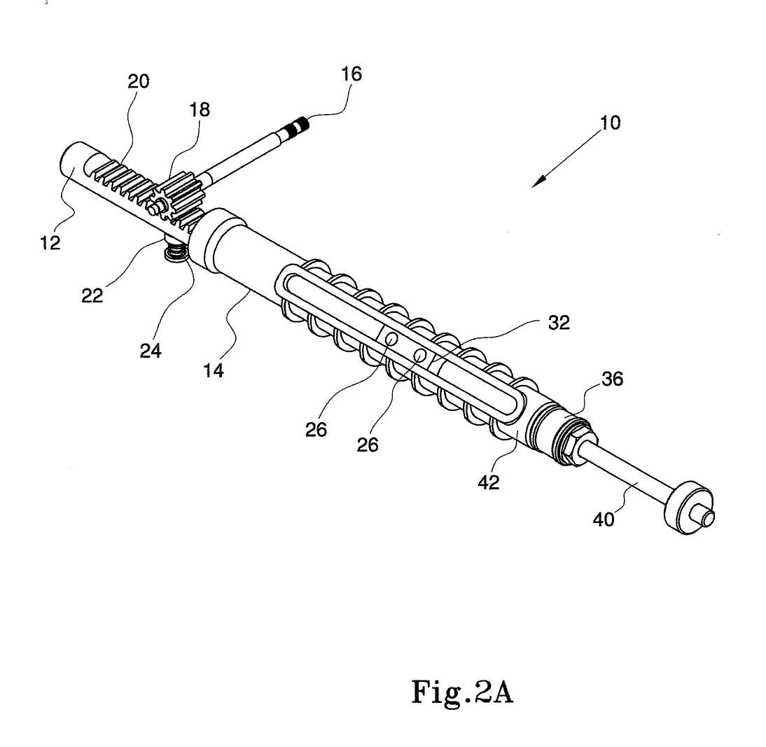

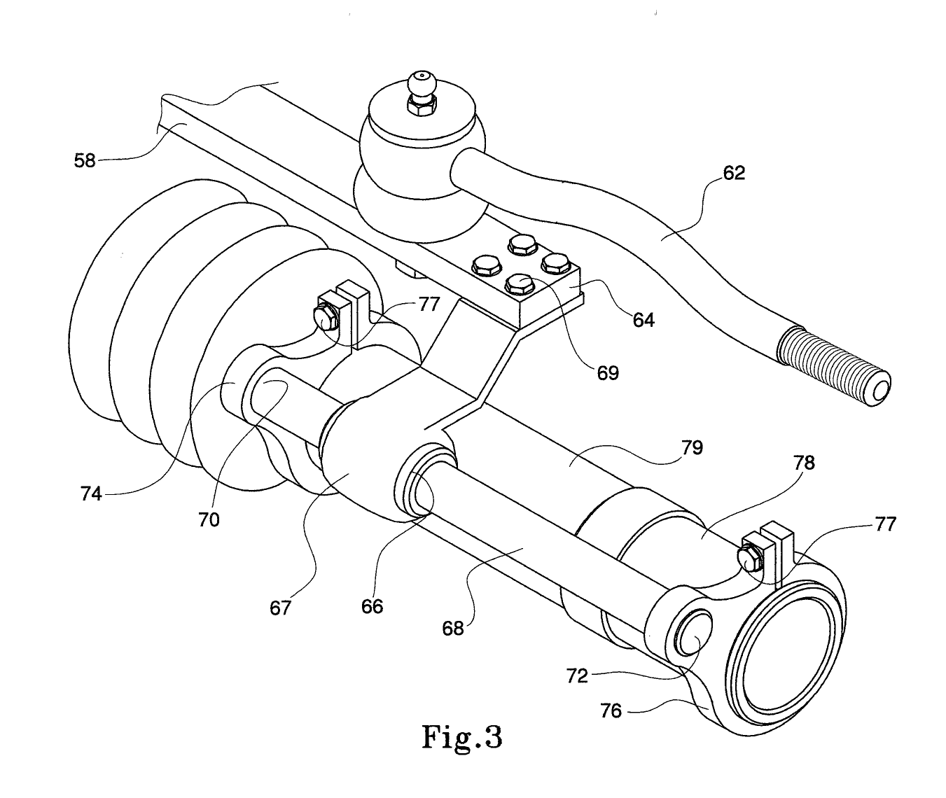

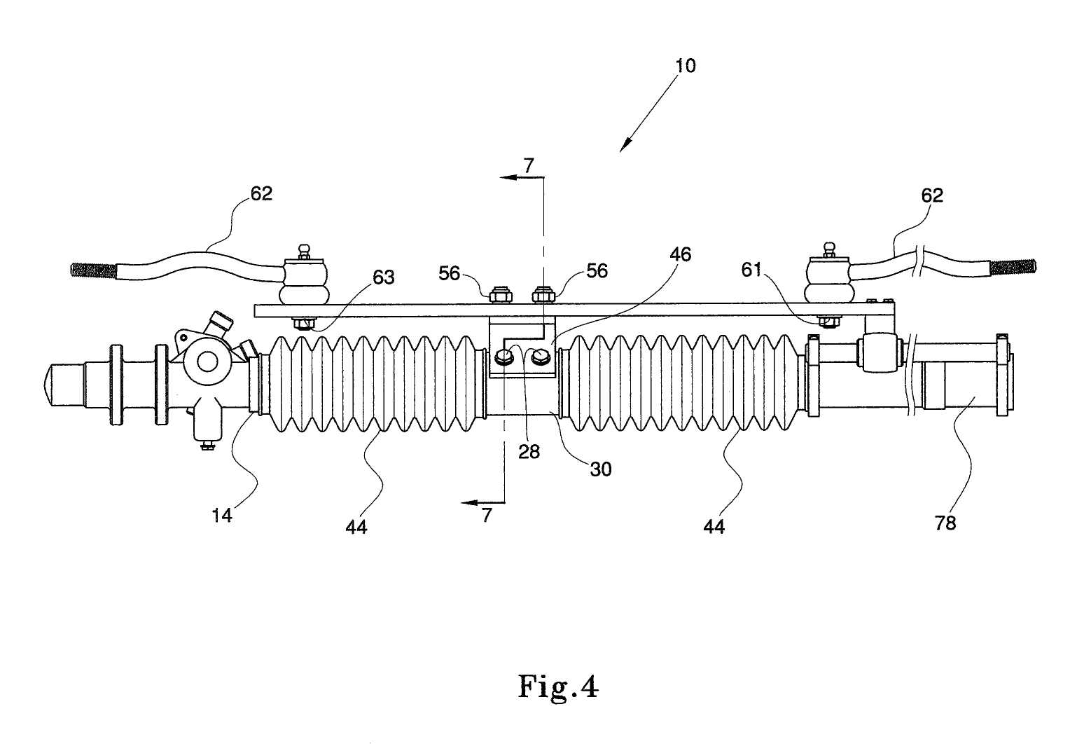

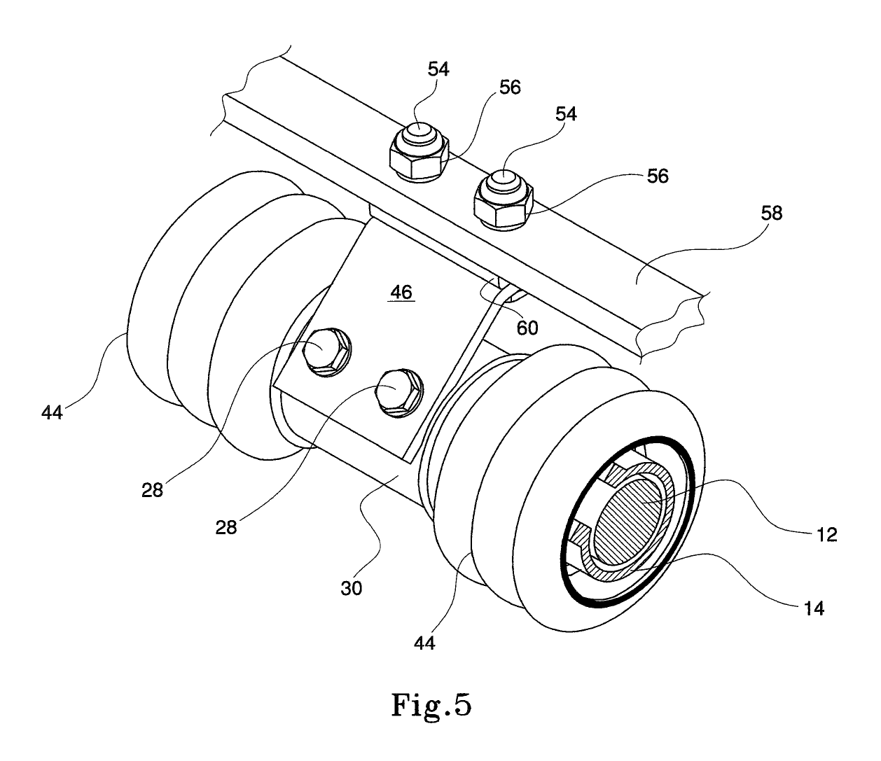

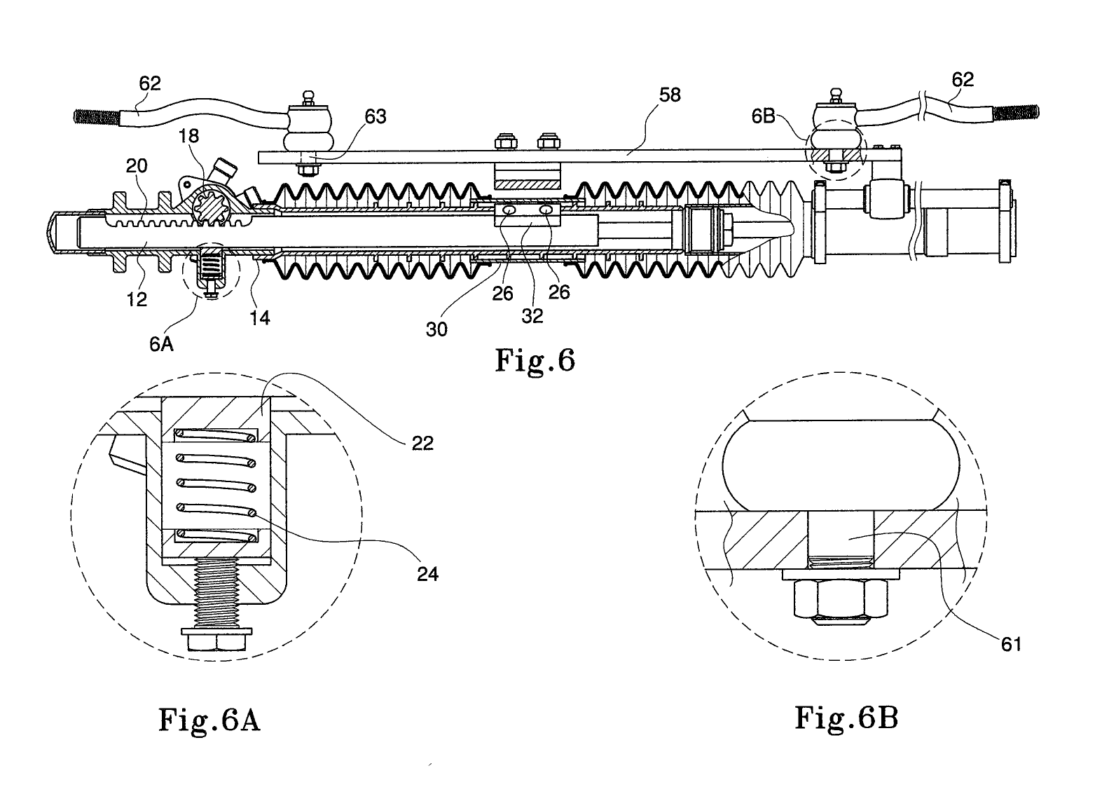

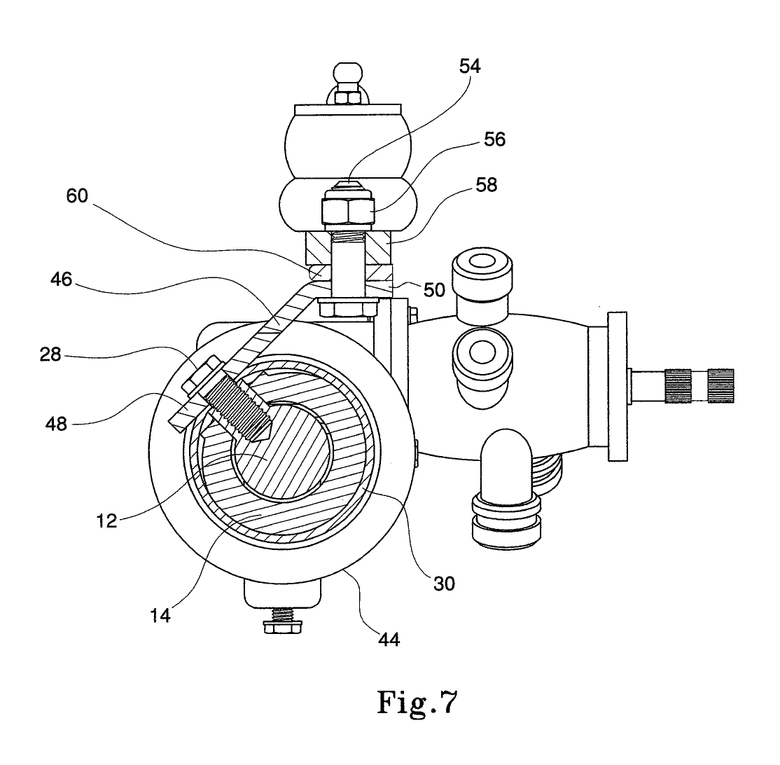

The steering tube assembly 14 shown in FIGS. 1 to 7 includes an extension tube 78, which is an interference press fit onto the main or original tube 79. The extension tube 78 includes a female bell end 80 that is a press fitted over the free end 82 of the main tube 79. The inner bracket 74 mounts to the main tube 79 and the other bracket 76 mounts to the extension tube 78. Both brackets may be mounted to the extension tube 78. It will be appreciated that, depending on the vehicle and the original steering tube, an extension tube may or may not be required and that if required the length of the extension tube 78 will be is sized to fit the vehicle.

The embodiment of shown in FIGS. 1 to 7 is a modification of an existing steering rack assembly. However, it will be appreciated that the invention includes OEM (original equipment manufacture) steering racks and the main tube 79 assembly may be manufactured to avoid a separate extension piece. Alternatively, by manufacturing the steering tube to one length and using appropriate extension pieces, a single design of steering assembly may be easily modified for different vehicle designs.

In most OEM steering racks the free end 82 of the main tube 79 is left open and a rubber or metal sleeve is mounted to the free end in which the free end of the steering rack 12 may move into. Where an extension tube 78 is used, the extension tube 78 replaces the rubber or metal sleeve.

The use of the adaptor plate 46 and spacer 60 allows the steering tube assembly to be mounted on the vehicle chassis with optimal alignment of the steering input shaft relative to the steering wheel; the adaptor plate compensates for rotation of steering tube about its axis and the spacer 60 allows the drag bar 58 to clear the steering tube and any associated equipment.

The drag bar 58 allows sideways positioning of the steering tube assembly to be optimized and the position of the tie bar mounting holes and the drag bar may be adjusted to provide for optimal positioning of the tie rods and optimal length of the tie rods.

It is not essential that the adaptor plate 46 be angled or even present. The drag bar 58 may be mounted directly to the steering rack 12 via the bores 26. A suitable spacer may be required, which may be a separate component or incorporated into the drag bar 58. The adaptor plate may be configured to shift the drag bar 58 fore or aft relative to the steering rack 12 and/or to rotate the drag bar 58 relative to the steering rack 12, or neither. This may be achieved by appropriate sizing and angling of the two sections of the adaptor plate 46.

Whilst the drag bar used in the preferred embodiment provides no fore and aft offset of the tie bar mounting points, it is within the scope of the invention for these mounting points to be offset relative to the adaptor mounting points.

Whilst the first embodiment has the linear bearing assembly 66, 68 located at the other end of the steering tube assembly 14 from the geared pinion wheel 18, if desired the linear bearing assembly may be attached to the other end of the drag bar 58 and positioned at the same end of the steering tube assembly 14 as the pinion wheel 18.

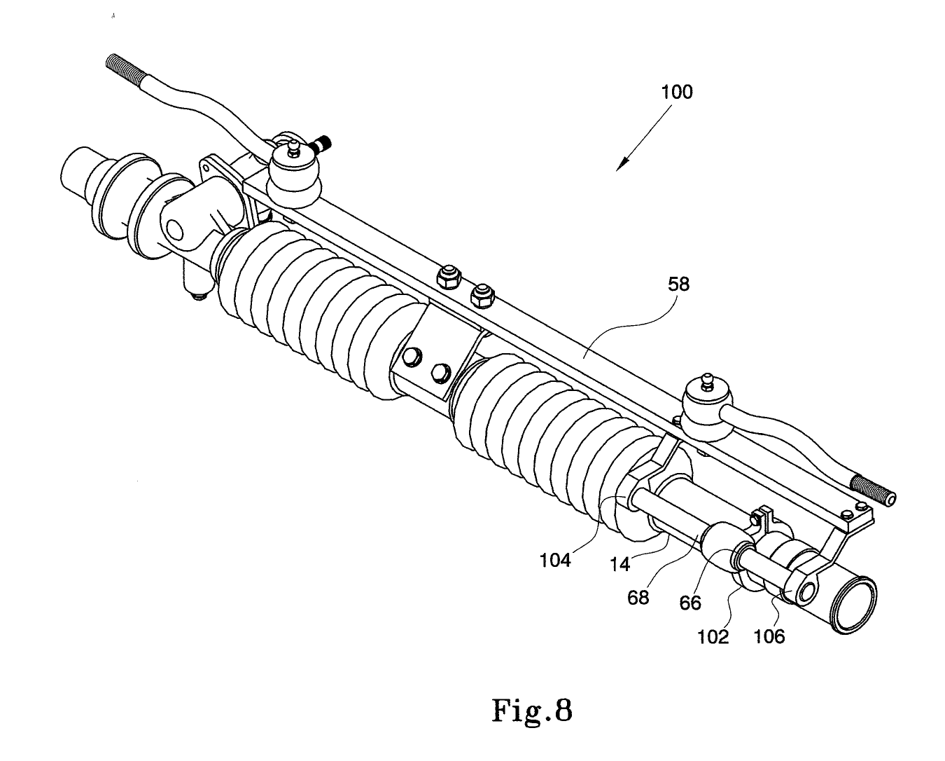

FIG. 8 shows a second embodiment of the invention 100 in which the linear bearing 66 is mounted to the steering tube assembly 14, via bracket 102. The stabilizer rod 68 is attached to the drag bar 58 via brackets 104 and 106. The brackets 104 and 106 are secured to each end of the stabilizer rod 68 with the linear bearing 66 in between. If desired, the stabilizer rod 66 may be cantilevered from the drag bar and secured to the drag bar toward an inner end with the linear bearing sliding on the free end portion. A single bracket, such as bracket 104, may be used. Alternatively two brackets may be used, located adjacent to, and preferably spaced apart from, each other at the inner end.

The second embodiment may also be configured with the stabilizer bar and linear bearing at the same end of the steering tube assembly 14 as the pinion wheel 18.

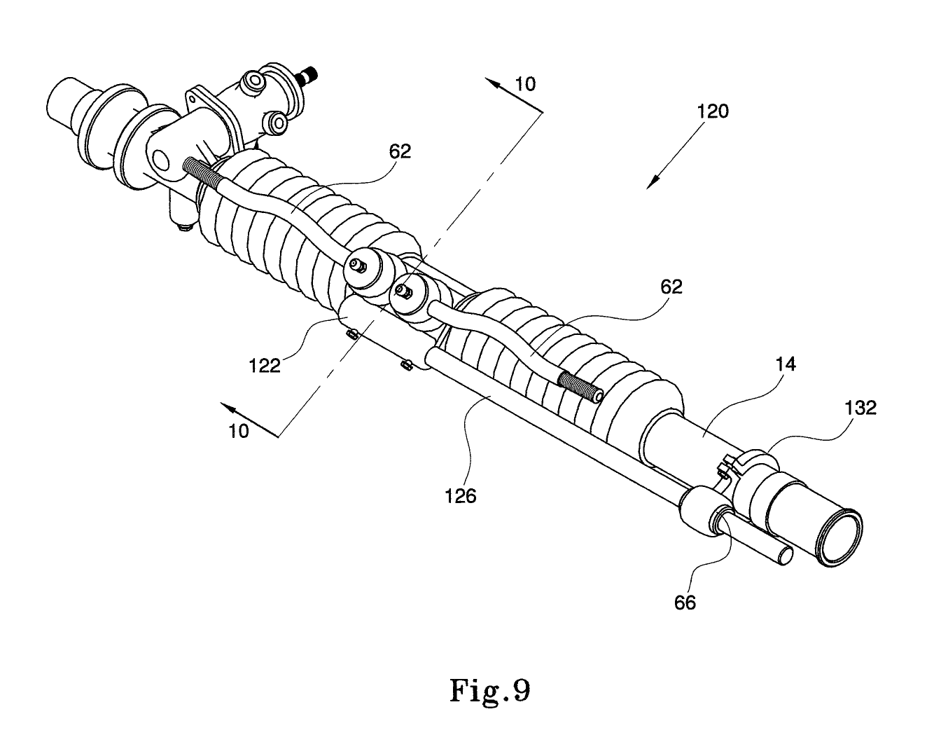

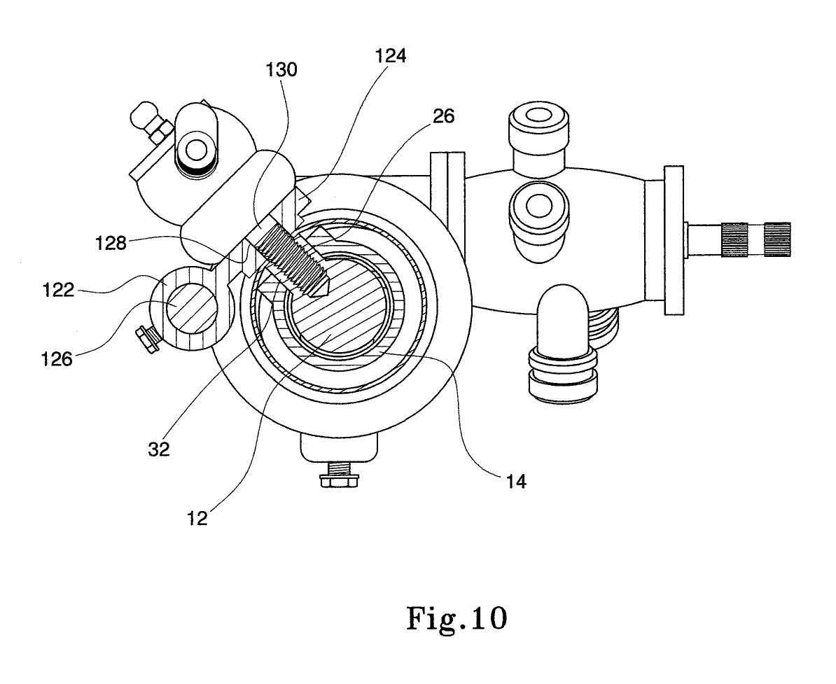

FIG. 9 shows a third embodiment of the invention 120 in which the tie rods 62 are mounted to the steering rack 12 via bores 26 in the mounting part 32. Sandwiched between the tie rods and the steering rack 12 is an elongate stabilizer assembly 122. The stabilizer assembly 122 includes a mounting flange 124 and a rod section 126. The mounting flange 124 has two apertures 128 through which the tie rod bolts 130 pass to secure the stabilizer assembly to the steering rack 12, with the rod section 126 parallel to the steering rack 12. A linear bearing 66 is mounted on the steering tube assembly 14 via a bracket 132 and the rod section 126 slides in the linear bearing 66. As with the other embodiments, the stabilizer assembly may extend toward the pinion wheel 18 with the linear bearing located toward that end.

The stabilizer assembly 122 which may be formed as a single unit, such as by forging or machining or may be made of multiple components. These components may be welded or otherwise permanently joined together or assembled using releasable fasteners, such as with screws, nuts and bolts or similar fasteners.

It will be apparent to those skilled in the art that many obvious modifications and variations may be made to the embodiments described herein without departing from the spirit or scope of the invention.

I claim:

1. A steering assembly including:
an elongate steering tube assembly;
an elongate steering rack mounted within the steering tube assembly for lengthways reciprocal motion therein;
a linear bearing assembly located outside of the steering tube assembly and connected between the steering rack and the outside of the steering tube assembly.

2. The steering assembly of claim 1 wherein the linear bearing assembly includes a linear bearing and a stabilizer rod extending substantially parallel to the steering rack, one of the linear bearing and the stabilizer rod connected to the steering rack and the other connected to the steering tube assembly.

3. The steering assembly of claim 2 wherein steering rack includes a mounting location and the linear bearing assembly has a first part connected to the steering rack at the mounting location.

4. The steering assembly of claim 3 wherein the mounting location is intermediate the ends of the steering rack.

5. The steering assembly of claim 3 wherein the linear bearing is connected to the first part.

6. The steering assembly of claim 2 wherein the stabilizer rod is connected to the steering tube assembly via two brackets, the brackets mounted at each end of the stabilizer rod.

7. The steering assembly of claim 3 wherein the stabilizer rod is connected to the first part.

8. The steering assembly of claim 3 wherein the stabilizer rod is a part of the first part.

9. The steering assembly of claim 3 wherein the first part extends longitudinally on both sides of the mounting location.

10. The steering assembly of claim 3 wherein the first part includes at least one pair of tie rod mounting points.

11. The steering assembly of claim 10 wherein the mounting location is nearer to one tie rod mounting point of a pair than to the other.

12. The steering assembly of claim 10 wherein the tie rod mounting points are offset forward or aft relative to the mounting location.

13. The steering assembly of claim 3 including at least one spacer between the first part and the steering rack.

14. The steering assembly of claim 13 wherein the at least one spacer includes a first spacer, the first spacer including a first section connected to the steering rack and a second section, to which the first part is connected.

15. The steering assembly of claim 14 wherein the first and second sections extend at an angle to each other.

16. The steering assembly of claim 14 wherein the first and second sections extend at an angle of about 45 degrees to each other.

17. The steering assembly of claim 14 wherein the first and second sections are substantially coplanar.

18. The steering assembly of claim 13 wherein the at least one spacer includes a second spacer, located between the first part and the first spacer.

19. The steering assembly of claim 1 wherein the steering tube assembly includes a main tube and an extension tube.

20. The steering assembly of claim 19 wherein linear bearing assembly is at least partially mounted on the extension tube.

21. The steering assembly of claim 19 wherein the extension tube is located at a first end of the steering tube assembly.

22. The steering assembly of claim 1 wherein the steering tube assembly includes a drive mechanism that engages the steering rack at or adjacent a second end thereof and wherein the linear bearing assembly is connected to the steering tube assembly at or adjacent a first end thereof.

23. A conversion kit for a centre steer steering assembly in which an elongate steering rack is mounted for reciprocal motion in an elongate steering tube assembly, the steering rack having a tie rod mounting location intermediate its ends, the kit including:
a linear bearing assembly for connection between the tie rod mounting location and the outside of the steering tube assembly.

24. The conversion kit of claim 22 wherein the linear bearing assembly includes a linear bearing and a stabilizer rod which, in use, extends substantially parallel to the steering rack, one of the linear bearing and the stabilizer rod adapted to be connected to the steering rack and the other adapted to be connected to the steering tube assembly.

25. The conversion kit of claim 23 wherein the linear bearing assembly includes a first part connected to the steering rack.

26. The conversion kit of claim 24 including at least one bracket for mounting the first part to the steering rack.

27. The steering assembly of claim 25 wherein the linear bearing is connected to the first part.

28. The conversion kit of claim 23 including two brackets to connect the stabilizer rod to the steering tube assembly.

29. The conversion kit of claim 25 wherein the stabilizer rod is connected to the first part.

30. The conversion kit of claim 25 wherein the stabilizer rod is a part of the first part.

31. The conversion kit of claim 25 wherein, in use, the first part extends longitudinally on both sides of the mounting location.

32. The conversion kit of claim 25 wherein the first part includes at least one pair of tie rod mounting points.

33. The conversion kit of claim 32 wherein the tie rod mounting location is nearer to one tie rod mounting point of a pair than to the other.

34. The conversion kit of claim 32 wherein the tie rod mounting points are offset forward or aft relative to the tie rod mounting location.

35. The conversion kit of claim 25 including at least one spacer which, in use is located between the first part and the steering rack.

36. The conversion kit of claim 34 wherein the at least one spacer includes a first spacer which, in use is connected between the steering rack and the first part.

37. The conversion kit of claim 35 wherein the first spacer includes a first section connected to the steering rack and a second section, to which the first part is connected.

38. The conversion kit of claim 37 wherein the first and second sections extend at an angle to each other.

39. The conversion kit of claim 37 wherein the first and second sections extend at an angle of about 45 degrees to each other.

40. The conversion kit of claim 37 wherein the first and second sections are substantially coplanar.

41. The conversion kit of claim 23 including an extension tube for connection on an end of the steering tube assembly.

42. The conversion kit of claim 41 wherein, in use, the linear bearing assembly is at least partially mounted on the extension tube.
